(19) United States
(12) Patent Application Publication
(10) Pub. No.: US 2024/0139959 A1
(43) Pub. Date: May 2, 2024

(54) PROGRAM GENERATION DEVICE AND ROBOT CONTROL DEVICE

(71) Applicant: FANUC CORPORATION, Yamanashi (JP)

(72) Inventors: Wanfeng FU, Yamanashi (JP); Yuta NAMIKI, Yamanashi (JP)

(73) Assignee: FANUC CORPORATION, Yamanashi (JP)

(21) Appl. No.: 18/546,710

(22) PCT Filed: Apr. 19, 2021
(86) PCT No.: PCT/JP2021/015896

§ 371 Date: Aug. 16, 2023

(51) Int. Cl. B25J 9/16

(52) U.S. Cl. CPC B25J 9/1692

(57) ABSTRACT

The present invention facilitates calibration of a robot system. A program generation device according to one embodiment of the present disclosure generates a calibration program that defines a procedure for calibration Los setting a positional relationship between a visual sensor and a robot in a robot system is which the robot is operated on the basis of a detection result from the visual sensor. The program generation device comprises: a calibration information acquisition unit for acquiring information about the calibration performed in accordance with a teacher's input; and a program generation unit for generating a calibration program that defines, on the basis of the information about the calibration acquired by the calibration information acquisition unit, a procedure for the calibration to be performed the next time and thereafter.

### TECHNICAL FIELD

The present invention relates to a program generation device and a robot control device.

### BACKGROUND ART

Such a robot system that uses a visual sensor, that is, a camera, checks a position of an object, and determines operation of a robot is widely utilized. In the robot system as described above, for example, calibration for setting a relationship between the visual sensor and the robot, that is, a transformation matrix for converting a coordinate system of the visual sensor into a coordinate system of the robot is performed. For example, Patent Document 1 describes that a visual target jig provided with a dot pattern is used to calibrate a visual sensor.
Patent Document 1: Japanese Patent No. 5670416

### DISCLOSURE OF THE INVENTION

### Problems to be Solved by the Invention

When maintenance is performed, for example, when a camera is replaced, in a robot system, it is necessary to perform calibration again. Furthermore, there may be cases where it is desirable to periodically perform calibration to secure the accuracy of the robot system. However, calibration of a robot system is a burdensome task involving complicated steps such as specifying a position of a robot. Therefore, such a technology has been demanded that makes it possible to facilitate calibration of a robot system.

### Means for Solving the Problems

A program generation device according to an aspect of the present disclosure is a program generation device that generates a calibration program that defines a procedure for calibration for setting a positional relationship between a visual sensor and a robot in a robot system in which the robot is operated based on a detection result from the visual sensor, and that includes: a calibration information acquisition unit that acquires information about the calibration performed in accordance with an input by a teacher; and a program generation unit that generates a calibration program that defines, based on the information about the calibration, the information being acquired by the calibration information acquisition unit, a procedure for the calibration to be performed a next time and thereafter.

A robot control device according to another aspect of the present disclosure is a robot control device that causes a robot to operate based on a detection result from a visual sensor, and that includes: an initial calibration control unit that receives an input by a teacher, causes the robot to operate in accordance with the input by the teacher, and performs calibration for setting a positional relationship between the visual sensor and the robot; a calibration information acquisition unit that acquires information about the calibration performed by the initial calibration control unit; a program generation unit that generates a calibration program that defines, based on the information about the calibration, the information being acquired by the calibration information acquisition unit, a procedure for the calibration to be performed a next time and thereafter; and a re-calibration control unit that performs the calibration in accordance with the calibration program generated by the program generation unit.

### Effects of the Invention

According to the present disclosure, it is possible to provide a program generation device and a robot control device that makes it possible to facilitate calibration of a robot system.

### BRIEF DESCRIPTION OF THE DRAWINGS

FIG. 1 is a schematic view illustrating a configuration of a robot system including a robot control device according to an embodiment of the present disclosure; and

FIG. 2 is a schematic view illustrating a configuration of a robot system utilizing a program generation device according to an embodiment of the present disclosure.

### PREFERRED MODE FOR CARRYING OUT TI-JR INVENTION

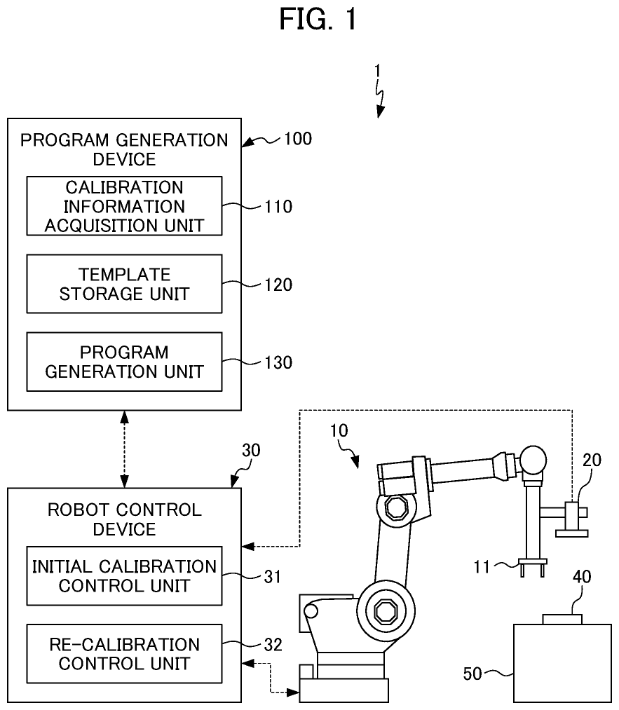

Embodiments of the present disclosure will now be described herein with reference to the accompanying drawings. FIG. 1 is a schematic view illustrating a configuration of a robot system 1 including a program generation device 100 according to an embodiment of the present disclosure.

The robot system. 1 includes a robot 10, a visual sensor 20 held by the robot 10, a robot control device 30 that causes the robot 10 to operate based on a detection result from the visual sensor 20, and the program generation device 100.

The robot 10 includes a head 11 for performing a task at its tip and holds the visual sensor 20 immovably relative to the head 11. The head 11 is, for example, a hand that holds a workpiece (not shown) or a tool that machines a workpiece, which is appropriately selected in accordance with a task that the robot 10 is caused to perform.

The robot 10 positions the visual sensor 20 together with the head 11. It is possible that the robot 10 is, but not limited to, such a vertical articulated robot as exemplified in FIG. 1, or may be an orthogonal coordinate robot, a scalar robot, or a parallel link robot, for example.

The visual sensor 20 is a device that detects visual information of a target, that is, captures an image of a subject, and is typically a two-dimensional camera that captures a two-dimensional visual-light image, and, furthermore, may be a three-dimensional sensor that acquires distance information per a two-dimensional position.

It is possible to achieve the robot control device 30 by causing one or a plurality of computer devices including a memory, a central processing unit (CPU), an input-and-output interface, and other components to execute appropriate control programs, for example.

The robot control device 30 identifies a position of a workpiece based on a detection result from the visual sensor 20 and controls operation of the robot 10 to position the head 11 with respect to the workpiece and to perform a task on the workpiece. To perform such a task on a workpiece as described above, it as required, in the robot system 1, to perform beforehand calibration for setting a positional relationship between the visual sensor 20 and the robot 10, that is, a transformation matrix allowing calculation of a coordinate position in a coordinate system of the robot 10 from a coordinate position in a detection result (in a captured image) from the visual sensor 20.

For this purpose, the robot control device 30 includes an initial calibration control unit 31 and a re-calibration control unit 32. Note that the initial calibration control unit 31 and the re-calibration control unit 32 represent categorized functions of the robot control device 30, and may not be clearly divided from each other in their physical configuration and program configuration, and may share an identical functional module.

The initial calibration control unit 31 receives an input by a teacher of the robot system 1, causes the robot 10 to operate in accordance with the input by the teacher, and performs calibration for setting a positional relationship between the visual sensor 20 and the robot 10. The calibration performed by the initial calibration control unit 31 may be similar to calibration performed with such a conventional method as described in Japanese Patent No. 5670416, for example.

The calibration is performed by disposing a predetermined calibration jig 40 in a workspace of the robot 10. The calibration jig 40 has, for example, a configuration having a plurality of characteristic points such as a dot pattern that the visual sensor 20 easily detects. The calibration jig 40 is fixed at a particular coordinate position in the coordinate system of the robot 10. It is desirable that the calibration jig 40 is always fixed on a table 50 on which the workpiece is to be placed, for example.

The initial calibration control unit 31 first determines a posture of the robot 10 in accordance with an input by the teacher, and then causes the visual sensor 20 to capture an image of the calibration jig 40. When a two-dimensional image is used to perform calibration, it is desirable that the visual sensor 20 is placed at a plurality of different start positions to capture images of the calibration jig 40 from the respective different positions.

Next, the initial calibration control unit 31 sets a positional relationship between the visual sensor 20 and the robot 10 based on a detection result from the visual sensor 20, that is, the images in which the calibration jig 40 is captured. Specifically, from positions of the plurality of characteristic points in the images of the calibration jig 40, a position and an orientation of the calibration jig 40 in the coordinate system of the visual sensor 20 are calculated. Then the transformation matrix is adjusted to allow a position and an orientation when the calculated position and the calculated orientation are converted into coordinates in the coordinate system of the robot 10 based on the posture of the robot 10 to coincide with the actual position and the actual orientation of the calibration jig 40 or a position and an orientation of the calibration jig 40, which are calculated from other viewpoint positions.

It is preferable that the initial calibration control unit 31 causes the robot control device 30 or an external display to display in a real-time manner a captured image by the visual sensor 20, and further provides a graphical interface that prompts the teacher to input necessary information. Examples of such information necessary for calibration include, but are not limited to, an input of imaging conditions for the visual sensor 20, an input of information about the calibration jig 40, an input of a viewpoint position at which imaging is performed, a selection of a calculation method for the calibration, a selection of characteristic points utilized for actual calculations from the characteristic points of the calibration jig 40, which are detected in a captured image, and an approval of a calibration result. Example configurations for prompting such inputs include, but are not limited to, check boxes, selection boxes, text boxes, and buttons. An input of a viewpoint position may be provided as an input in a user coordinate system, which differs from the robot coordinate system (for example, a coordinate system based on the table 50 on which the calibration jig 40 and a workpiece are to be placed).

The re-calibration control unit 32 performs calibration in accordance with a calibration program generated by the program generation device 100. It is possible to generate and create a program under an instruction provided by the teacher upon the completion of initial calibration. Otherwise, it may be automatically generated upon the completion of initial calibration. In addition, calibration by the re-calibration control unit 32 may be performed when the teacher has provided an instruction, may be performed periodically, specifically, performed upon the completion of a first task after a set period of time has passed, or may be performed automatically after the robot system 1 is first started or stopped after a set period of time has passed.

A calibration program may be described in a language used in typical numerical control devices. Therefore, detailed description of operation of the re-calibration control unit 32 is omitted.

It is possible to achieve the program generation device 100 by causing one or a plurality of computer devices, which include(s) a memory, a CPU, an input-and-output interface, and other components, for example, and which is or are communicably coupled to one or a plurality of the robot control devices 30, to execute appropriate control programs. The program generation device 100 may be achieved as a function of a computer device provided to manage or monitor a plurality of the robot systems 1.

The program generation device 100 includes a calibration information acquisition unit 110, a template storage unit. 120, and a program generation unit 130. Note that these components represent categorized functions of the program generation device 100, and may not be clearly divided from each other in their physical configuration and program configuration.

The calibration information acquisition unit 110 acquires information about calibration performed by the initial calibration control unit 31. Such acquired information about calibration is regarded as information that is sufficient to allow calibration performed by the initial calibration control unit 31 to reappear, including, but not limited to, a viewpoint position of the visual sensor 20 in calibration performed by the initial calibration control unit 31 or a posture of the robot, which identifies the viewpoint position, and set values of imaging conditions for the visual sensor 20, for example.

The template storage unit 120 stores a plurality of templates for calibration programs that each define a calibration procedure. The templates each have a configuration into which a user coordinate system, the type of the visual sensor 20, a viewpoint position, and other factors are written to create a program for performing identical calibration to one performed by the initial calibration control unit 31, without requiring an input by a teacher.

The templates stored in the template storage unit 120 are provided to the program generation unit 130 described later for generating a calibration program. Furthermore, the templates stored in the template storage unit 120 may be provided to the initial calibration control unit 31 for defining a control procedure performed by the initial calibration control unit 31.

Next, an example template among the templates for calibration programs, which are stored in the template storage unit 120, will be described below.

### (Template 1)

1: user coordinate number=*1
2: tool coordinate number=*2
3: each axis position [*3] 100% positioning
4:
5: position registration=orthogonal position
6: position registration [99,1]=0
7: position registration [99,2]=
8: position registration [99,4]=
9: position registration [99,5]=0
10: position registration [99,6]=
11:
12: ! calibration surface 1 detection
13: position registration [99,3]=0
14: each axis position [*3] 100% positioning and position compensation, position registration
15:
16: vision camera calibration ‘*4’ calibration surface=1
17:
18: ! calibration surface 2 detection
19: position registration. [99,3]=*5
20: each axis position [*3] 100% positioning and position compensation, position registration
21:
22: vision camera calibration ‘*4’ calibration surface=2
23: end

In this template, after values are entered in “*1”, “*2”, “*3”, “*4”, and “*5”, a calibration program is completed.

In the calibration instructed by this program, the visual sensor 20 performs imaging twice to set a positional relationship between the visual sensor 20 and the robot 10. The indication “*1” represents a code that identifies a “user coordinate number”, that is, a user coordinate system, and a value inputted by the teacher into the initial calibration control unit 31. The indication “*2” represents a code that identifies a “tool coordinate number”, that is, a coordinate system of the head 11, and a value inputted by the teacher into the calibration control unit 31. The indication “*3” represents a number indicating a position in the memory storing the viewpoint positions at which the visual sensor 20 has first performed imaging in the calibration performed by the initial calibration control unit 31. The indication “*4” represents a code that identifies a subprogram that identifies a detailed calculation procedure for calibration specified per the type of the visual sensor 20. The indication “*5” represents a distance in a Z direction between a viewpoint position at which first imaging is to be performed and a viewpoint position at which second imaging is to be performed.

The program generation unit 130 generates a calibration program that defines, based on the information about the calibration, which is acquired by the calibration information acquisition unit, a procedure for the calibration to be performed a next time and thereafter.

It is desirable that the program generation unit 130 generates a calibration program to allow a posture of the robot 10 in the calibration performed by the initial calibration control unit 31 in accordance with an input by a teacher to reappear. That is, it is desirable that the program generation unit 130 generates a calibration program that automatically sets again a positional relationship between the visual sensor 20 and the robot 10 by causing the visual sensor 20 to perform imaging at the viewpoint position in the calibration performed by the initial calibration control unit 31. By allowing the calibration that is performed by the initial calibration control unit 31 and that the teacher has determined its appropriateness to reappear, it is possible to perform again appropriate calibration, making it possible to accurately compensate errors which have occurred due to aging and during maintenance, for example.

It is possible to generate such a calibration program that allows calibration performed by the initial calibration control unit 31 to reappear by selecting a template in accordance with information about the calibration, which is acquired by the calibration information acquisition unit 110, and inputting, into the selected template, data identifying the posture of the robot 10, which is specified in the calibration performed by the initial calibration control unit 31 in accordance with the input by the teacher. As described above, using such a template makes it possible to easily and securely allow calibration performed by the initial calibration control unit 31 to reappear.

As described above, with the robot system 1 in which, after calibration is first performed once, the program generation device 100 generates a calibration program that defines a procedure for calibration to be performed the next time and thereafter, it is possible to automatically perform calibration the next time and thereafter.

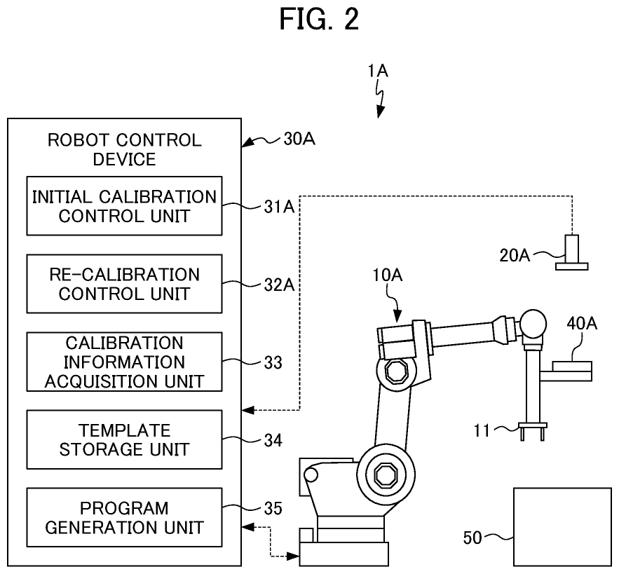

FIG. 2 is a schematic view illustrating a configuration of a robot system 1A including a robot control device 30A according to another embodiment of the present disclosure. For the present embodiment, like reference numerals designate components that are identical to the components according to the first embodiment, and duplicated descriptions may be omitted.

The robot system 1A includes a robot 10A, a visual sensor 20A that is fixed at a position from which it is possible to view a whole workspace of the robot 10A, and the robot control device 30A that causes the robot 10A to operate based on a detection result from the visual sensor 20A.

The robot 10A includes the head 11 for performing a task at its tip, to which a calibration jig 40A is fixed immovably relative to the head 11.

The visual sensor 20A is disposed immovably in the workspace and is able to capture an image of the calibration jig 40A transferred by the robot 10A.

The robot control device 30A includes an initial calibration control unit 31A, a re-calibration control unit 32A, a calibration information acquisition unit 33, a template storage unit 34, and a program generation unit 35.

The initial calibration control unit 31A and the re-calibration control unit 32A of the robot control device 30A illustrated in FIG. 2 perform similar processing to that performed by the initial calibration control unit 31 and the re-calibration control unit 32 of the robot control device 30 illustrated in FIG. 1, except that the coordinate system is different due to the arrangement of the visual sensor 20A and the calibration jig 401.

The calibration information acquisition unit 33, the template storage unit 34, and the program generation unit 35 of the robot control device 30A illustrated in FIG. 2 respectively have similar functions to those of the calibration information acquisition unit 110, the template storage unit 120, and the program generation unit 130 of the program generation device 100 illustrated in FIG. 1.

Therefore, with the robot system 1A in which, after calibration is first performed once, the program generation unit 35 of the robot control device 30A generates a calibration program that defines a procedure for calibration to be performed the next time and thereafter, it is possible to automatically perform the calibration the next time and thereafter.

Although the embodiments of the robot system according to the present disclosure have been described, the present invention is not limited to the embodiments described above. Furthermore, the effects according to the embodiments described above correspond to the most preferable effects that are derived from the present invention, and that are merely listed. The effects of the present invention are not however limited to the effects according to the embodiments described above.

As an example, a program generation device that is separated from a robot control device may be provided in a robot system in which a visual sensor is fixed with respect to a workspace. A calibration information acquisition unit, a template storage unit, and a program generation unit may otherwise be provided in a robot control device of a robot system in which a visual sensor is fixed with respect to a robot.

Although, in the embodiments described above, a calibration jig having a plurality of characteristic points is used, a calibration jig having a single characteristic point may be used, as described in Japanese Patent No. 6396516, for example. That is, capturing a plurality of images by changing a posture of a robot to differentiate a relative position between a visual sensor and a calibration jig having a single characteristic point makes it possible to perform calibration that is equivalent to one using a calibration jig having a plurality of characteristic points. In this case, a program generation unit has a configuration where a plurality of images are captured by changing a posture of a robot to generate a calibration program that identifies a coordinate system of the visual sensor from the plurality of captured images.

Furthermore, the calibration program described in the above-described embodiments is a mere example, and its language (its description format) and a described procedure may be appropriately selected based on the common technical knowledge. Furthermore, in calibration for a robot system, not only a transformation matrix for changing coordinates, but also parameters for compensating positioning errors that may occur due to deflection of the arm of a robot, play in gears, and other factors, for example, may be set.

### EXPLANATION OF REFERENCE NUMERALS

1, 1A Robot system.
10, 10A Robot
11 Head
20, 20A Visual sensor
30, 30A Robot control device
31, 31A Initial calibration control unit
32, 32A Re-calibration control unit
33 Calibration information acquisition unit
34 Template storage unit
35 Program generation unit
40, 40A Calibration jig
100 Program generation device
110 Calibration information acquisition unit
120 Template storage unit
130 Program generation unit

1. A program generation device that generates a calibration program that defines a procedure for calibration for setting a positional relationship between a visual sensor and a robot in a robot system in which the robot is operated based on a detection result from the visual sensor, the program generation device comprising:
a calibration information acquisition unit that acquires information about the calibration performed in accordance with an input by a teacher; and
a program generation unit that generates a calibration program that defines, based on the information about the calibration, the information being acquired by the calibration information acquisition unit, a procedure for the calibration to be performed a next time and thereafter.

2. The program generation device according to claim 1, wherein the program generation unit generates the calibration program to allow a posture of the robot in the calibration performed in accordance with the input by the teacher to reappear.

3. The program generation device according to claim 1,
further comprising a template storage unit that stores a plurality of templates for the calibration program,
wherein the program generation unit selects one of the templates in accordance with the information about the calibration, the information being acquired by the calibration information acquisition unit, inputs, into the selected one of the templates, data identifying the posture of the robot, the posture being specified in the calibration performed in accordance with the input by the teacher, and generates the calibration program.

4. A robot control device that causes a robot to operate based on a detection result from a visual sensor, the robot control device comprising:
an initial calibration control unit that receives an input by a teacher, causes the robot to operate in accordance with the input by the teacher, and performs calibration for setting a positional relationship between the visual sensor and the robot;
a calibration information acquisition unit that acquires information about the calibration performed by the initial calibration control unit;
a program generation unit that generates a calibration program that defines, based on the information about the calibration, the information being acquired by the calibration information acquisition unit, a procedure for the calibration to be performed a next time and thereafter; and
a re-calibration control unit that performs the calibration in accordance with the calibration program generated by the program generation unit.
